(19) United States
(12) Patent Application Publication
(10) Pub. No.: US 2024/0281559 A1
(43) Pub. Date: Aug. 22, 2024

(54) R-GRAPH PROPAGATION OF DATA PROTECTION AND COMPLIANCE STATUSES

(71) Applicant: HYCU, Inc., Boston, MA (US)

(72) Inventors: Goran Garevski, Ljubljana (SI); Subbiah Sundaram, Boston, MA (US)

(21) Appl. No.: 18/426,614

(22) Filed: Jan. 30, 2024

Related U.S. Application Data
(60) Provisional application No. 63/442,139, filed on Jan. 31, 2023.

(51) Int. Cl. G06F 21/62

(52) U.S. Cl. CPC G06F 21/6245; G06F 21/6227

(57) ABSTRACT

A method for assessing data resilience status of a data processing environment that includes generating a model of data processing resources within the environment, generating a data resilience-graph (R-graph) based the model, the R-graph including an object for each resource. The object for each resource further includes at least a compliance attributed and a criticality attribute. The method may then display a domain-specific view by applying compliance and criticality rules to the objects in the R-graph.

### CROSS REFERENCE TO RELATED APPLICATIONS

This patent application claims priority to:
U.S. Provisional Patent Appl. No.: 63/442,138 entitled “DISCOVERY OF SERVICES IN COMBINATION WITH ENABLING DATA PROTECTION AND OTHER WORKFLOWS, Filed Jan. 31, 2023;
U.S. Provisional Patent Appl. No.: 63/442,139 entitled R-GRAPH PROPAGATION OF DATA PROTECTION AND COMPLIANCE STATUSES, Filed: Jan. 31, 2023; and
U.S. Provisional Patent Appl. No.: 63/442,140 entitled API MODEL FOR AS-A-SERVICE DATA RESILIENCE MANAGEMENT Filed: Jan. 31, 2023;
the entire contents of each of which are hereby incorporated by reference.

### TECHNICAL FIELD

This patent application relates to methods and systems for determining data resiliency, including data protection and compliance status, for complex data processing environments.

### BACKGROUND

Many organizations have 10s to 100s to 1000s of different applications, services, systems, data sources and other data processing resources that support their operations. The ability to understand if the data processing resources used by an organization are protected or complaint is a continuing challenge. The status of such entities is not a simple “good/bad” parameter (especially from a data protection perspective). For example, data critical to an organization may be protected, and even most workloads might be protected. However, when other workloads have failed, reliance on the status of a data backup alone may lead to an incorrect conclusion that the business as a whole is protected.

Cloud Services (e.g., SaaS (software as a service), PaaS (Platform as a Service), DBaaS (Database as a Service, IaaS (Infrastructure as a Service)) have become an integral part of many business computing environments. The advantages of these cloud services are well known and include the ability to scale to meet demand as needed, and to only pay for what it needed. It is also expensive and time-consuming to maintain any software application on a regular basis. However, with these “as-a-Service” deployments, the service provider may itself provide for data backup and maintenance, including data protection, which frees the business' own staff from complex software and hardware management.

One consideration is that some SaaS applications provide their own internal backup and data protection methods. In addition, a final data protection policy for an organization may consist of multiple layers. These data protection layers may include SaaS internal backup, and separate Data Protection as a Service (DPaaS) products (such as those provided by HYCU, Inc.), as well as other methods for data replication, archiving, and the like. More generally, business operations are considered to be protected when a Service Level Objective (SLO) is achieved, regardless of the implementation specifics. Thus the actual status of an enterprises' data protection may not match what the expectations are.

### SUMMARY OF PREFERRED EMBODIMENT(S)

What is needed is a way for an organization to quickly assess their data resilience, such as data protection and compliance status, both as a whole and for individual departments and/or functions. However, a mere count of applications, services, and data sources that are protected or not protected is insufficient. A better solution should enable Information Technology (IT) managers/CIO/CISOs to get a quick view of whether they should take immediate action or not. The solution should take into consideration that:
a) even if applications/data sources are not protected they may or may not be critical;
b) just because an important resource is not protected or not in compliance, does not mean the organization needs to panic—because other alternate sources might already be providing a solution; and
c) modern applications and services are usually a complex distributed architecture of various services and data across different technology stacks (and/or computing environments or public/private clouds)—thus, individual items' protection/compliance does not mean the protection of the required application/service.

The systems and methods described herein enable organizations to automate the creation of the holistic data protection and compliance status across and within complex applications, services, and organizations. The ability to understand this overall status can be crucial for IT personnel to be able to monitor, manage and report against the top-level business services.

The ability to calculate and propagate this status from within an organization unit or across the overall organization is a complex task.

The approach taken here determines the data protection and compliance status for an organization's data processing resources on a per-organization-unit basis. The protection and compliance status is determined across the entire data processing environment, including hosted applications (which may include combinations of physical or virtual machines, databases, and storage devices), cloud services (which may include workloads, data storage, and services on SaaS or other services such as those provided by Google). The approach provides insight into the status of the overall organization (e,g., top level corporate) or at other (e.g., a department or operational) organization levels.

In some embodiments, a processor may generate a model of data processing resources within a data processing environment. Generally speaking, a “data processing resource” may include any feature, service, product, or attribute of the service to which a policy may be assigned. A data resilience-graph (R-graph) may be generated based the model, where the R-graph includes an object for each resource group. where for example, each resource group may include one or more resources. Each resource group may be represented by a leaf in the R-graph. The object for each resource group may further include at least a compliance or protection attribute and a criticality attribute. A processor may display a domain-specific view by applying compliance and criticality rules to the objects in the R-graph.

In some aspects, the techniques described herein relate to a method for assessing data resilience status of a data processing environment including: generating a model of data processing resources within the environment; generating a data resilience-graph (R-graph) based the model, the R-graph including an object for each resource, the object for each resource further including at least a compliance attribute and a criticality attribute; applying compliance and criticality rules to the objects in the R-graph; and displaying a domain-specific view of the R-graph.

In other aspects, the techniques described herein relate to an apparatus for assessing compliance status of a data processing environment including: one or more data processors; and one or more computer readable media including instructions that, when executed by the one or more data processors, cause the one or more data processors to perform a process for: generating a model of data processing resources within the environment; generating a data resilience-graph (R-graph) based the model, the R-graph including an object for each resource, the object for each resource further including at least a compliance attribute and a criticality attribute; applying compliance and criticality rules to the R-graph; and displaying a domain-specific from the resulting R-graph.

### BRIEF DESCRIPTION OF THE DRAWINGS

Features and advantages of the approaches discussed herein are evident from the text that follows and the accompanying drawings, where:

FIG. 1 shows a model of a data processing environment that is augmented with a Data Resilience Graph (“R-Graph”) and domain-specific viewer.

FIG. 2 is a typical data processing environment in more detail.

FIG. 3 is an example architecture of a complex application.

FIG. 4 is one example of an R-Graph.

FIG. 5 illustrates example attributes of R-Graph entities.

FIG. 6 is a table that describes the complete logic for propagation of the protected status in the environment.

FIG. 7 is a resulting display of compliance illustrating criticality.

FIG. 8 is an example high level flow for applying the propagation logic.

### DETAILED DESCRIPTION OF PREFERRED EMBODIMENT(S)

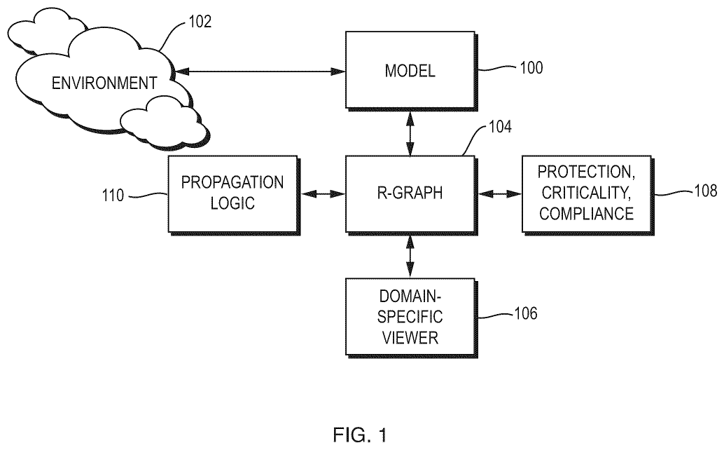

FIG. 1 shows how a model 100 of a data processing environment 102 can be augmented with a Data Resilience Graph (“R-Graph”) 104 and a domain-specific viewer 106 to improve the way in which the environment protects its data. A typical enterprise's data processing environment 102 may consist of a wide variety of resources such as hosted applications, services, public/private clouds, servers, storage, databases, processors, and many other types of data processing elements. The model 100 of these resources may be developed and maintained in different ways such as via Simple Network Management Protocol (SNMP), Common Information Model (CIM), or other methods that define how the managed resources in an IT environment 102 are represented as a common set of objects and relationships between them.

The Model 100 may include the ability to collect the compliance and protection status of the managed resources. As is known in the art, this status information may be automatically discovered via agents, plug-ins, via Application Programming Interfaces (APIs) and the like installed in the managed resources. However this information may also be collected in other ways, such as manually. The collected status information is then stored in a Data Resilience Graph (“R-Graph”) data structure 104, an example of which is discussed in more detail below.

The R-Graph 104 may be augmented with criticality information 108 that is further processed by rules we call propagation logic 110. The criticality 108 for a particular resource may differ depending on the perspective of different domains, such as departments or functions, within the enterprise. Thus a given resource may have different criticality values for different domains.

A viewer application 106 then provides a display of one or more aspects of the R-Graph to an IT manager or other user after application of the propagation logic 110. The display generated by the viewer 106 is tailored to the specific domain of interest. For example, the user may only be interested in the compliance status from the perspective of a particular department in an enterprise. A typical modern company has dozens of complex business applications and services which are at the heart of the business availability status. Some of them are critical to the operation of the business, some of them have a standard importance, and some of them have almost no impact on the core business. Or perhaps upper level management prefers to know the status of the organization as a whole, and considers all of the systems that support a given department (such as sales or manufacturing) more critical than another department's systems (such as engineering). Thus, a resource considered critical by one department may not be critical for another.

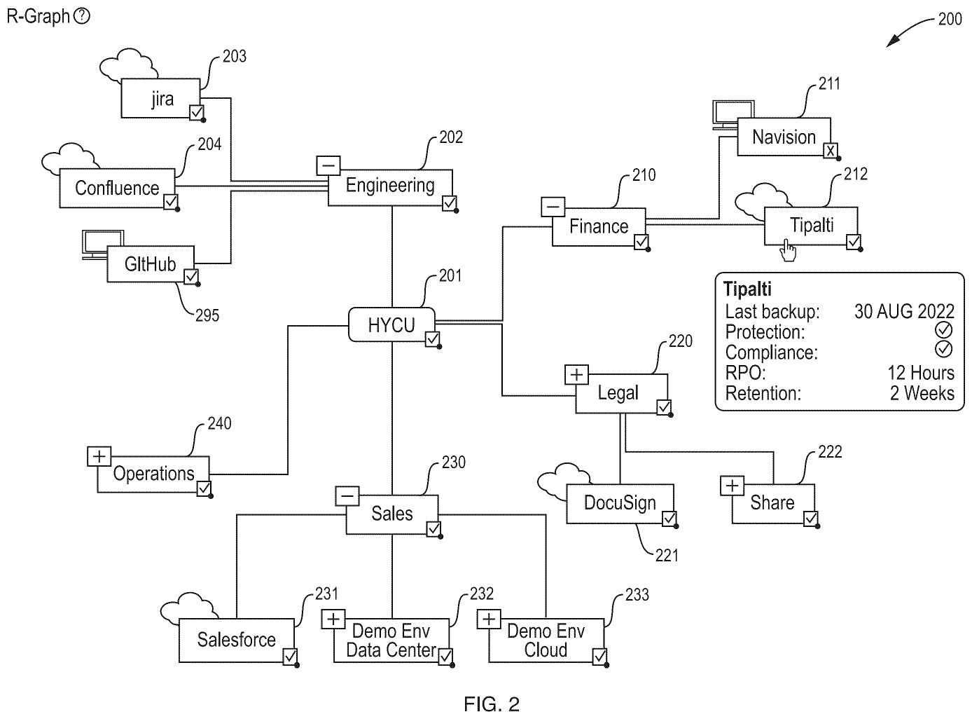

FIG. 2 shows an example R-graph 200 for an example enterprise 201 that uses a mix of Software as a Service (SaaS) resources and hosted resources.

In this example, the Engineering department 202 uses Jira 203, Confluence 204, and GitHub 205 services they access as SaaS; the Finance Department 210 uses Navision 211 and Tipalti 212; Legal 220 uses Docusign 221 and a shared data repository 222; the Sales Department 230 uses SalesForce 232, and a couple of hosted resources (a Demo Data Center 234 and Demo Cloud 236), and Operations 240 does not yet have any managed resources. The user's mouse is hovering over the Tipalti 212 resource and can see it was last backed up on 30 Aug. 2022. The checkmarks next to the different resources indicate their compliance status; an “x” indicates a resource that is not in compliance (e.g., Navision). A “shield” next to a resource may indicate the data protection status for the node, and a “dot” next to a resource may indicate its compliance status.

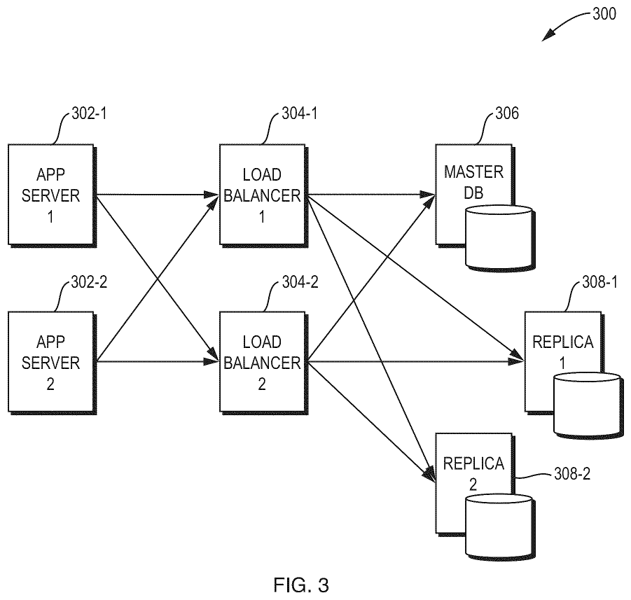

FIG. 3 is an example architecture of a complex hosted application 300. It consists of a set of resources including pair of application servers 302-1, 302-2, a pair of load balancers 304-1, 304-2, a master database 306, and a pair of replica databases 308-1, 308-2.

The ability to understand the health, data protection status and compliance of the different SaaS services in use as depicted in the example enterprise of FIG. 2 as well as a hosted application (as shown in the example of FIG. 3) requires an algorithm we call propagation logic herein that takes into consideration:
data protection status
compliance SLOs
criticality

To this end, the Model 100 collects this data protection, compliance, and criticality information for each resource. To obtain a result for whether the hosted application of FIG. 3 as whole is protected, the SLO may specify that it is sufficient if only one of the replicas is protected. Thus the resulting R-Graph propagation logic 110 may determine that the application is protected if Replica 1 OR Replica 2 is protected. However in an other enterprise, the SLO may specify the need for both Replica 1 AND Replica 2 to be protected for the application as a whole to be considered to be protected. And the SLO may consider the Replicas to be considered “critical”, but still specify that Replica 1 “OR” Replica 2 is sufficient since they are replicas and not the Master Database.

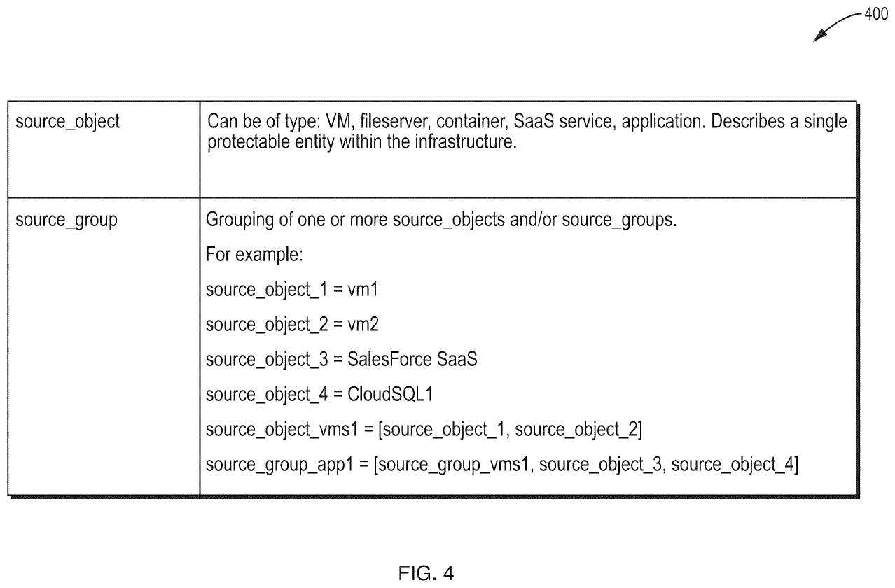

Every organization's protectable data processing resources (entities) can thus be described by tracking the entities shown in the example table 400 of FIG. 4 in an R-Graph 104. The type of source object can specified as various types (e.g., virtual machine (VM) fileserver, container, SaaS service, application, etc.). Groups of resources can also be defined and the groups can be nested. In this example, a “VMs” group consists of the two virtual machines (vm1, vm2) and an “application 1” group consists of the VMs group, a SalesForce SaaS and a CloudSQL service.

In this way any business application, service or data can be described environment, including even the overall organization(with a group that groups everything at a top level).

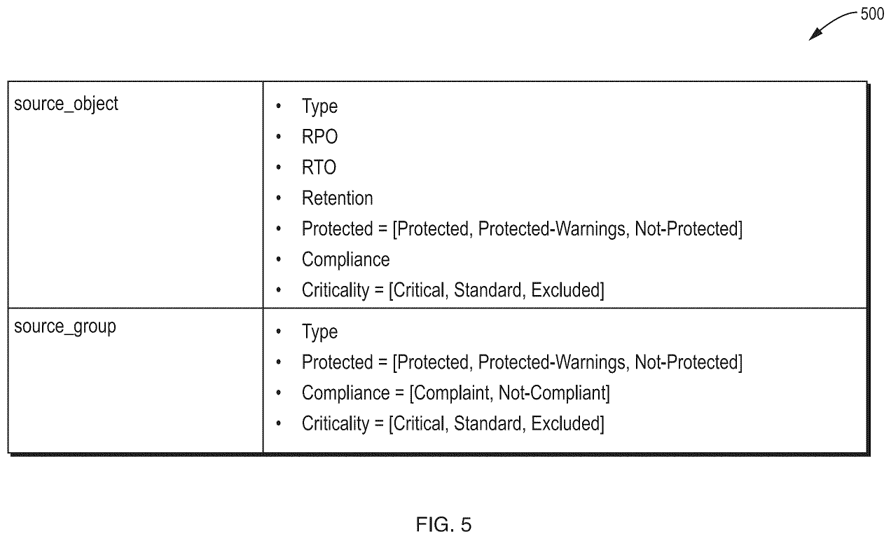

FIG. 5 illustrates a table 500 that is but one example of the possible attributes of R-Graph entities in more detail. Here a source object may have further attributes other than just a type, such as
RPO (Recovery Point Objective)
RTO (Recovery Time Objective)
Retention (Retention Policy)
Protected Status=[Protected, Protected-With-Warnings, Not-Protected]
Compliance Status
Criticality Status=[Critical, Standard, Excluded]

The R-Graph may also implement certain rules for propagation of their individual protected and compliance status of “child” members of a larger hierarchy or group.

For example, rules for “Propagation of Protected Status” may include:

All children with Criticality=‘Critical’ must be protected to have the group status protected.

At least one child with Criticality=‘Standard’ must be protected in order to propagate the group status as protected.

Protected status of a child with Criticality=‘Excluded’ does not affect the status of the group.

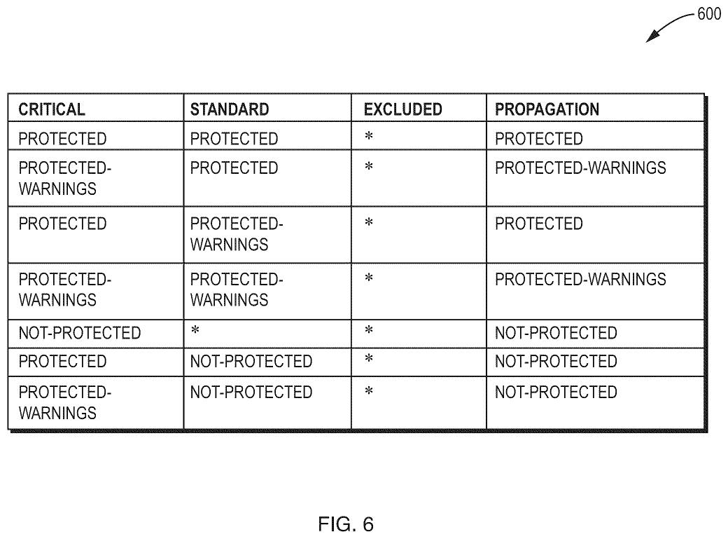

FIG. 6 is an example of a table 600 that describes the propagation logic 104 for propagation of protected status, depending on the criticality of the resource.

More particularly, example rules for propagation of compliant status may include:

All children with Criticality=‘Critical’ must have ‘Compliant’ status in order to propagate ‘compliant’ to the group.

All children with Criticality=‘Standard’ and of type source_group must have ‘Compliant’ status in order to propagate ‘compliant’ to the group.

At least one child with Criticality=‘Standard’ and of type source_object must have ‘Compliant’ status in order to propagate ‘compliant’ to the group.

Children with Protected=‘Not Protected’ should propagate to ‘not-protected’ as should any with Protected Warnings=‘Not Protected’.

The rules above describe examples of the complete logic for propagation of compliant status in the environment. Note that entries with Criticality=‘Excluded’ are not affecting the score.

It should be understood that additional or other compliance rules are possible. For example, Criticality may include Critical (Protected) and Standard (Not Protected) and a Propagation rule may include Protected with Warnings.

In addition, it is possible that the logic may include other conditions. For example, the user may be able to set criteria (such as equal to or greater than 50% of child resources) to trigger non-compliance or a warning to a higher level.

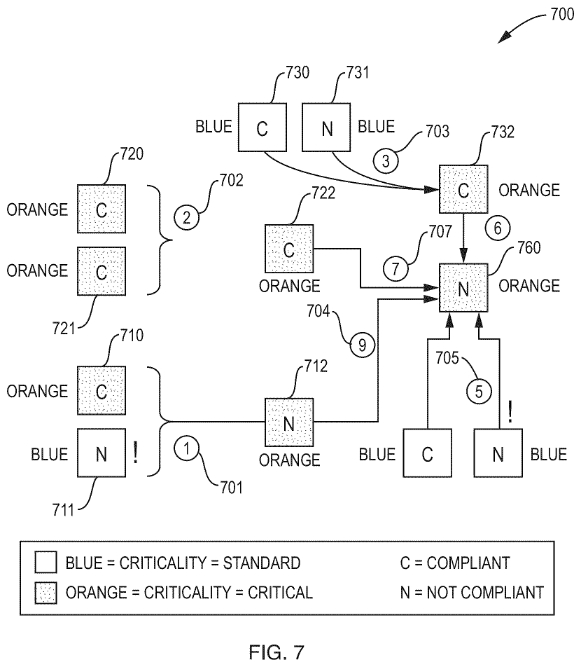

FIG. 7 is a resulting R-Graph 700 that shows how Criticality and Compliance propagate for a particular organization's resources. The rectangles represent managed resources, each of which may represent individual or groupings of applications or services, or a department's managed resources, or groups of applications. In the event a color version of this drawing is available, criticality is indicated by the color of each rectangle, with blue indicating standard criticality and orange indicating critical. Otherwise the color of each rectangle is indicated in the words next to it. The view may be of a particular department's resources or the entire enterprise.

In this example, at “Level 1” 701, a “critical/compliant” resource 710 (shown with an orange rectangle labeled “C”) and a “standard/non-compliant” resource 711 (shown with a blue rectangle labeled “N”) propagates to a “critical/non-compliant” resource 712 (an orange rectangle labled “N”). At “Level 2” 702, a pair of “critical/compliant” resources 720, 721 propagate to “critical/compliant” resource 722. “Level 3” 703 is a department that has a standard/compliant resource 730 and a standard/non-compliant resource 731 but which propagates to a “critical/compliant” resource 732 because of the nature of the department that Level 3 supports (perhaps it is the Sales department).

Thus someone viewing the graph at Level 2 would conclude that department's managed resources are “critical and compliant”. However, someone viewing the R-Graph at Level 1 would conclude that department's resources are “critical and non-compliant”, potentially exposing that immediate action may be needed.

The propagation logic 104 similarly processes the other Levels 704, 705, 706, 707 to generate the resulting overall view 700.

The overall view 700 of the propagated statuses of the entire organization exposes an overall non-compliant/critical status 760 , which may prompt some immediate action.

“Protection” and “compliance” propagation may not be absolute v (e.g., they need not always resolve to a “yes” and “no” answer. For example, different weightings or scales may be configured at different levels.

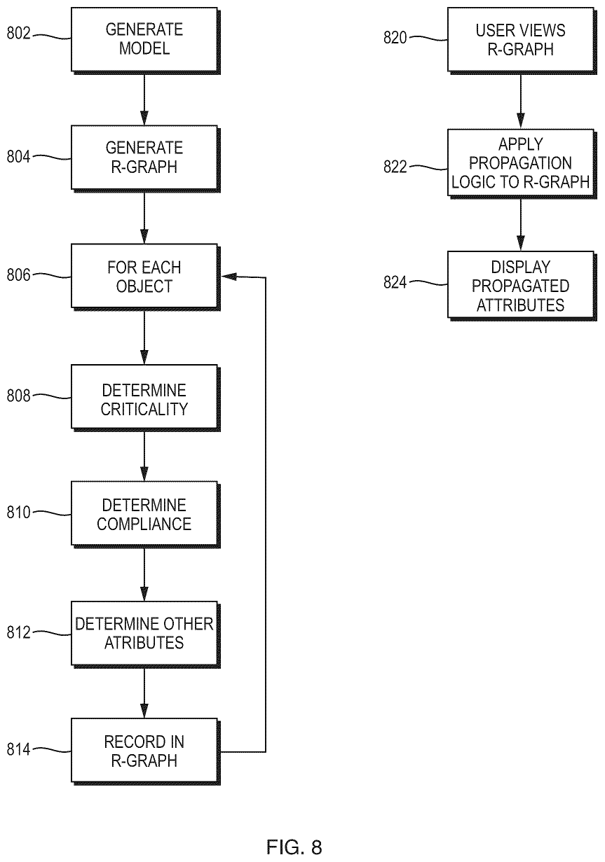

A process for generating an R-Graph representation of the Criticality and Compliance status of a particular enterprise's data resources can now be appreciated. One such example process is shown in FIG. 8.

In a first step 802, a model of the data processing resources in an enterprise is generated.

In step 804, an R-Graph is generated from the model as explained above.

Starting at step 806, this involves, for each object in the R-Graph, determining a criticality attribute (step 808) and a compliance attribute (step 810).

In step 812, other attributes for the object(s) may also be determined.

In step 814 these attributes are recorded for the object, and processing returns to step 806 until all objects are processed.

At some later point in time a user wishes to access the R-Graph in step 820.

The propagation logic is applied to the R-Graph in step 822.

The resulting propagated attributes are then displayed in step 824.

### Further Implementation Options

It should be understood that the workflow of the example embodiments described above may be implemented in many different ways. In some instances, the various “data processors” may each be implemented by a physical or virtual or cloud-based general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Embodiments may also leverage cloud data processing services such as Amazon Web Services, Google Cloud Platform, and similar tools.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. A method for assessing data resilience status of a data processing environment comprising:
generating a model of data processing resources within the data processing environment;
generating a data resilience-graph (R-graph) based the model, the R-graph including an object for each resource, the object for each resource further including at least a compliance attribute and a criticality attribute; and
applying compliance and criticality rules to the objects in the R-graph; and displaying a domain-specific view of the R-graph.

2. The method of claim 1 additionally wherein
the R-graph consists of a hierarchy of objects, and the domain-specific view is further generated by applying inheritance attributes of the compliance and criticality rules to the hierarchy of objects.

3. The method of claim 2 wherein the domain-specific view is for an entire enterprise, a department within the enterprise, an application, or a service.

4. An apparatus for assessing compliance status of a data processing environment comprising:
one or more data processors; and
one or more computer readable media including instructions that, when executed by the one or more data processors, cause the one or more data processors to perform a process for:
generating a model of data processing resources within the environment;
generating a data resilience-graph (R-graph) based the model, the R-graph including an object for each resource, the object for each resource further including at least a compliance attribute and a criticality attribute;
applying compliance and criticality rules to the R-graph; and
displaying a domain-specific view from the R-graph.

5. The apparatus of claim 4 additionally wherein
the R-graph consists of a hierarchy of objects, and the domain-specific view is further generated by applying inheritance attributes of the compliance and criticality rules to the hierarchy of objects.

6. The apparatus of claim 5 wherein the domain-specific view is for an entire enterprise, a department within the enterprise, an application, or a service.

7. A computer program product embodied in a non-transient medium for assessing compliance status of a data processing environment, the computer program product holding computer program instructions that, when executed by a data processing system, is configured for:
generating a model of data processing resources within the data processing environment;
generating a data resilience-graph (R-graph) based the model, the R-graph including an object for each resource, the object for each resource further including at least a compliance attributed and a criticality attribute; and
applying compliance and criticality rules to the objects in the R-graph; and
displaying a domain-specific view of the R-graph.

8. The computer program product of claim 7 additionally wherein the R-graph consists of a hierarchy of objects, and the domain-specific view is further generated by applying inheritance attributes of the compliance and criticality rules to the hierarchy of objects.

9. The computer program product of claim 7 wherein the domain-specific view is for an entire enterprise, a department within the enterprise, an application, or a service.
